(19) United States
(12) Patent Application Publication
(10) Pub. No.: US 2026/0287401 A1
(43) Pub. Date: Sep. 24, 2026

(54) Rotary Laser

(71) Applicant: Robert Bosch GmbH, Stuttgart (DE)

(72) Inventors: Ben William Carabelli, Leinfelden-Echterdingen (DE); Tobias Roehm, Wildberg-Sulz (DE)

(21) Appl. No.: 19/572,495

(22) Filed: Mar. 19, 2026

(30) Foreign Application Priority Data
Mar. 20, 2025 (DE) 10 2025 110 738.6

(51) Int. Cl. G01D 5/30

(52) U.S. Cl. CPC G01D 5/30

(57) ABSTRACT

A rotary laser includes a housing in which, for the purpose of rotating a laser beam, a drive unit with a stator and a rotor for the rotating drive of a spindle is arranged. A determination unit is associated with the spindle, which has a toothed disc and a photointerrupter, wherein the toothed disc has teeth distributed in the circumferential direction and a receptacle for accommodating a magnetic disc. The photointerrupter is provided for determining a relative change in the angular position of the spindle.

This application claims priority under 35 U.S.C. § 119 to patent application no. DE 10 2025 110 738.6, filed on Mar. 20, 2025 in Germany, the disclosure of which is incorporated herein by reference in its entirety.

### BACKGROUND

The present disclosure relates to a rotary laser having a housing in which, for the purpose of rotating a laser beam, a drive unit having a stator and a rotor for rotatably driving a spindle is arranged.

From the prior art, a rotary laser having such a drive unit for the purpose of rotating a laser beam is known. The drive unit is arranged in a housing of the rotary laser. Here, the drive unit has, for rotatably driving a spindle, a stator and a rotor.

### SUMMARY

The disclosure relates to a rotary laser having a housing in which, for the purpose of rotating a laser beam, a drive unit having a stator and a rotor for rotatably driving a spindle is arranged. The spindle is associated with a determination unit having a toothed disc and a photointerrupter, wherein the toothed disc has teeth arranged circumferentially and having a receptacle for accommodating a magnetic disc, and wherein the photointerrupter is provided for determining a relative change in an angular position of the spindle.

The disclosure thus makes it possible to provide a rotary laser in which the photointerrupter enables a simple and reliable determination of a relative change in an angular position of the spindle.

Preferably, the spindle has a magnet carrier with an inner shoulder and a circumferential collar, and the magnet disc is at least partially annular in shape with an interior recess, wherein the interior recess is located at the inner shoulder of the magnet carrier and the magnet disc rests against the circumferential collar along the longitudinal extension of the spindle.

Thus, a receptacle for the magnetic disc may be provided in a simple manner.

Preferably, the toothed disc has an interior recess located on the outer circumference of the circumferential collar.

An exact and precise arrangement of the toothed disc on the spindle can thus be enabled.

The toothed disc has a first positive-locking element in its interior recess, and the circumferential collar has a second positive-locking element on its outer circumference, whereby the first and second positive-locking elements form a positive-locking connection.

This allows for the easy and straightforward creation of a rotationally secure connection between the toothed disc and the spindle.

Adhesive is preferably applied between the bottom side of the magnetic disc—which faces the toothed disc—and the bottom surface of the toothed disc to form an adhesive bond.

This enables a secure and reliable attachment of the magnetic disc.

According to one embodiment, the magnetic carrier of the spindle and the toothed disc are formed as a single piece.

This provides an alternative toothed disc arrangement.

Preferably, the spindle has a circumferential collar along its longitudinal extension to secure its position.

This enables a secure and robust arrangement of the toothed disc on the spindle.

Preferably, the determination unit has a reference mark as an absolute reference.

This makes it easy to determine the absolute position of the spindle.

According to one embodiment, the reference mark is assigned to the toothed disc and is designed as a reference tooth or reference recess, wherein the teeth of the toothed disc have a first width and the reference tooth or the reference recess has a second width, wherein the second width is greater than the first width.

This makes it easy and uncomplicated to provide a suitable toothed disc for determining the absolute position of the spindle.

Preferably, the spindle is connected at its free end—the end facing away from the drive unit—to a beam deflector, wherein the spindle has a flattened portion for positioning the beam deflector, and wherein the beam deflector has a fastening section with a corresponding interior receptacle.

This makes it easy to securely mount the beam deflector on the spindle.

According to one embodiment, the reference mark is configured as a positioning feature on the magnetic disc and is operatively connected to an absolute encoder.

This means that an alternative reference mark can be provided simply and easily.

### BRIEF DESCRIPTION OF THE DRAWINGS

The disclosure is explained in more detail in the following description with reference to the exemplary embodiments shown in the drawings. They show:

FIG. 1 a perspective view of a rotary laser according to the present disclosure with a drive unit,

FIG. 2 a perspective exploded view of a spindle assigned to the drive unit of FIG. 1 and a bearing arrangement assigned to the spindle,

FIG. 3 a longitudinal section through the bearing arrangement of the spindle of FIG. 2 in the assembled state,

FIG. 4 a schematic view of the bearing arrangement of FIG. 2 and FIG. 3 as viewed from a free end of the spindle,

FIG. 5 a perspective view of the drive unit of FIG. 1 having a determination unit and a beam deflector,

FIG. 6 a longitudinal section through the drive unit of FIG. 5,

FIG. 7 a perspective view of the spindle of FIG. 2 to FIG. 6 having the determination unit of FIG. 5 and FIG. 6,

FIG. 8 a top view of a printed circuit board assigned to the drive unit of FIG. 1 to FIG. 7,

FIG. 9 a perspective view of the spindle of FIG. 2 to FIG. 8 having a toothed disc and the beam deflector of FIG. 1, FIG. 5, and FIG. 6,

FIG. 10 a longitudinal section through the bearing arrangement of the spindle and of the toothed disc of FIG. 9,

FIG. 11 a longitudinal section through the drive unit of FIG. 1 to FIG. 10 having an alternative fixing of the bearing arrangement,

FIG. 12 a perspective view of the spindle having the determination unit of FIG. 1, FIG. 5 to FIG. 7, and FIG. 9 to FIG. 11,

FIG. 13 a top view of the printed circuit board of FIG. 8 having an absolute encoder,

FIG. 14A a first top view of the spindle of FIG. 1 to FIG. 7 and FIG. 9 to FIG. 12 having the printed circuit board of FIG. 8 and the beam deflector of FIG. 1, FIG. 5, FIG. 6, and FIG. 9 in a calibration process,

FIG. 14B a second top view of the spindle of FIG. 1 to FIG. 7 and FIG. 9 to FIG. 12 having the printed circuit board of FIG. 8 and the beam deflector of FIG. 1, FIG. 5, FIG. 6, and FIG. 9 in a calibration process,

FIG. 14C a third top view of the spindle of FIG. 1 to FIG. 7 and FIG. 9 to FIG. 12 having the printed circuit board of FIG. 8 and the beam deflector of FIG. 1, FIG. 5, FIG. 6, and FIG. 9 in a calibration process,

FIG. 15A a first top view of the spindle with the printed circuit board and the beam deflector of FIG. 14A to FIG. 14C in an absolute positioning during a start of the rotary laser of FIG. 1,

FIG. 15B a second top view of the spindle with the printed circuit board and the beam deflector of FIG. 14A to FIG. 14C in an absolute positioning during a start of the rotary laser of FIG. 1,

FIG. 15C a third top view of the spindle with the printed circuit board and the beam deflector of FIG. 14A to FIG. 14C in an absolute positioning during a start of the rotary laser of FIG. 1,

FIG. 15D a fourth top view of the spindle with the printed circuit board and the beam deflector of FIG. 14A to FIG. 14C in an absolute positioning during a start of the rotary laser of FIG. 1,

FIG. 16 a partial longitudinal section through the rotary laser of FIG. 1,

FIG. 17 an exploded view of the beam deflector of FIG. 1, FIG. 5, FIG. 6, FIG. 9, FIG. 14A to FIG. 16 having a cap,

FIG. 18 a cross-sectional view of the beam deflector of FIG. 17 at a maximum deflection,

FIG. 19 a perspective view of the beam deflector of FIG. 1, FIG. 5, FIG. 6, FIG. 9, FIG. 14A to FIG. 18, and

FIG. 20 a cross-sectional view of the beam deflector of FIG. 18 without a cap, at a maximum deflection.

### DETAILED DESCRIPTION

Elements having the same or a comparable function are provided with the same reference signs in the figures and are described in detail only once.

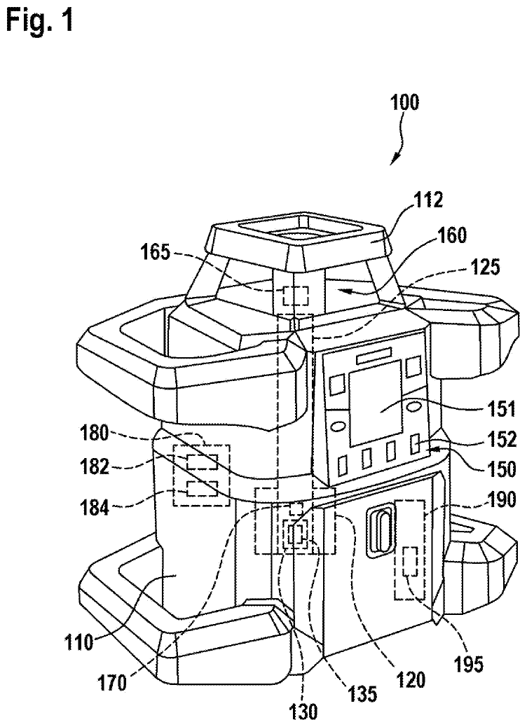

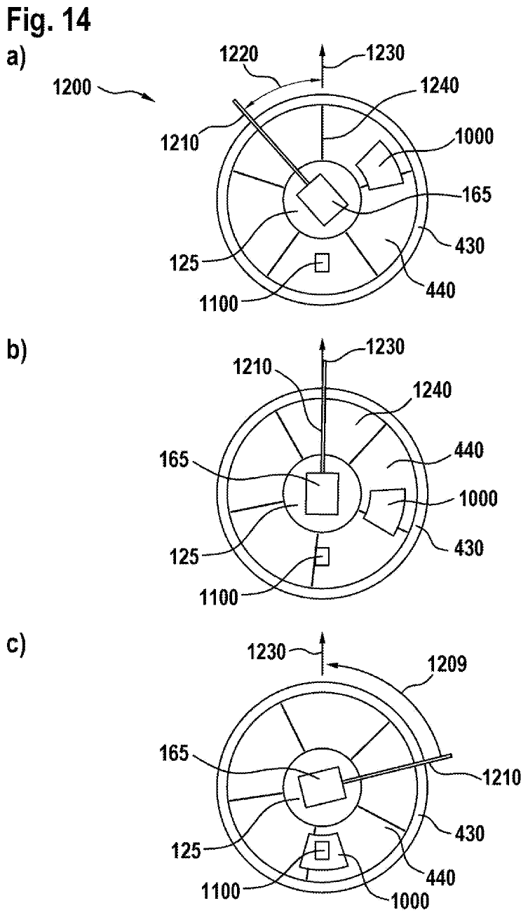

FIG. 1 shows an exemplary rotary laser 100 having a housing 110, in which a laser unit 130 having a laser diode 135 for generating a laser beam (1210 in FIG. 14A) is arranged. A “rotary laser” may also be understood in the context of the present disclosure to mean a construction laser or a leveling laser. Furthermore, housing 110 contains, by way of example, a drive unit 120 for rotating a spindle 125. The drive unit 120 is preferably configured as an electric motor.

The laser unit 130 is arranged on the spindle 125 such that, by rotation of the spindle 125, the laser beam (1210 in FIG. 14A) generated by the laser unit 130 rotates in an assigned plane. To this end, the spindle 125 is preferably associated with a rotary head 160 with a beam deflector 165. The beam deflector 165 is preferably configured to deflect the laser beam, whereby the laser beam (1210 in FIG. 14A) projects the assigned plane. Depending on the design of the rotary laser 100, the projected plane may be horizontal, vertical, or, e.g., at a defined inclination angle with respect to the earth's surface. Furthermore, the beam deflector 165 may be configured to be a beam splitter, whereby the laser beam is projected both into the plane and emitted along a direction perpendicular to the plane.

Moreover, an electronic unit 190 with a control and monitoring device 195 is preferably arranged in the housing 110. The control and monitoring device 195 is preferably configured to control the laser output of the laser unit 130 depending on a mode of operation in each case. A rotational speed of the spindle 125 of the drive unit 120 is thus controlled or regulated. Preferably, a determination unit 170 is associated with the spindle 125 for this purpose.

By way of example, a cage 112 associated with the rotary head 160 is associated with the housing 110 to protect the rotary head 160 from being struck.

The electronic unit 190 is illustratively associated with a operating unit 150 with a display 151 and an input unit 152. The operating unit 150 is preferably connected to the electronic unit 190, in particular to the control and monitoring device 195, for control or regulation purposes. The input unit 152 preferably comprises at least one keypad. Alternatively, the input unit 152 may comprise a rotary control, a touch screen, a slider, a remote control or the like. For example, via the input unit 152, a user may enter a rotational speed for the spindle 125. Alternatively, the rotational speed of the laser unit 130 can be controlled automatically in at least one operating mode.

Preferably, the rotary laser 100 has a leveling unit 180. The leveling unit 180 preferably has at least one inclination sensor 184, which is configured to ascertain an inclination of the rotary head 160, in particular, of the beam deflector 165, and/or of the laser unit 130 relative to a predefined direction, preferably a horizontal direction, or relative to the vertical. Moreover, the leveling unit 180 preferably has at least one inclination adjustment motor 182 configured to align the rotary head 160, in particular the beam deflector 165, and/or the laser unit 130, depending on a position determined by the at least one inclination sensor 184, preferably an inclination of the laser unit 130 and/or the rotary head 160, preferably in the vertical direction.

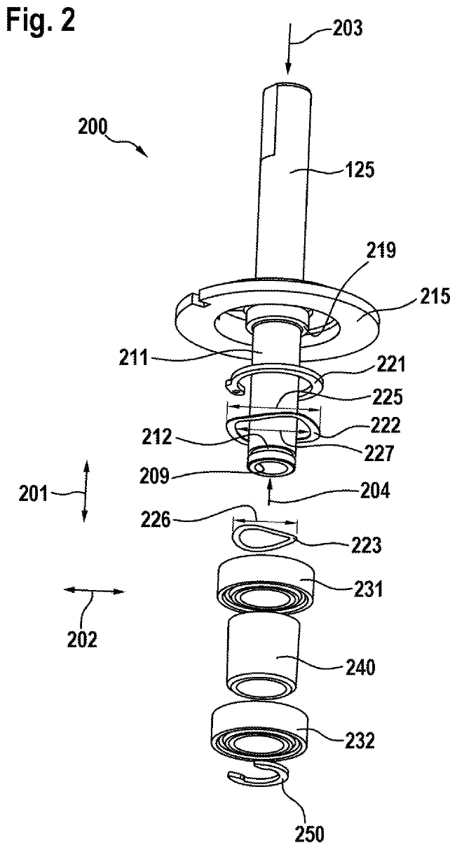

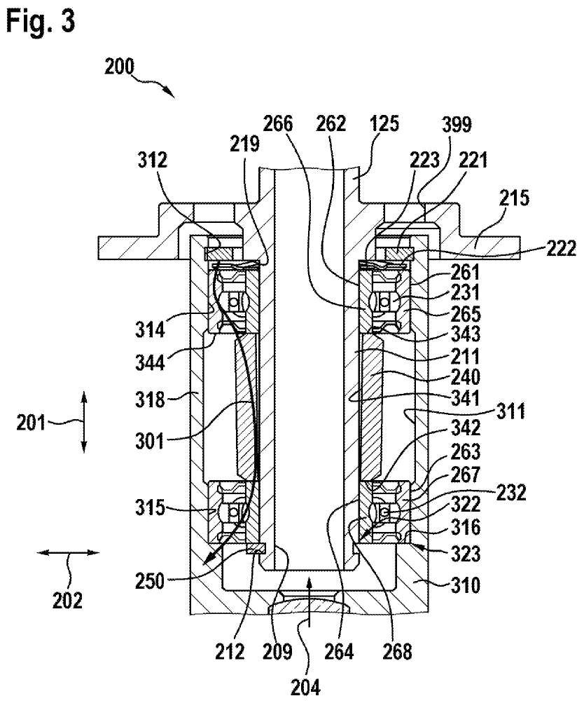

FIG. 2 shows the spindle 125 of the drive unit 120 of the rotary laser 100 of FIG. 1. The spindle 125 has a first, upper end 203 and a second, lower end 204. Preferably, the beam deflector 165 of FIG. 1 is arranged at the first end 203. At the second end 204, the spindle 125 is supported in a stator (310 in FIG. 3) via a bearing arrangement 200.

Preferably, the bearing arrangement 200 has two bearing elements 231, 232, via which the spindle 125 is supported in the stator (310 in FIG. 3). Preferably, a spacer element 240 is provided, which spaces the two bearing elements 231, 232 apart from one another along a longitudinal extension 201 of the spindle 125.

Preferably, a fixing element 221 for fixing the spindle 125 in the direction of its longitudinal extension 201 on the stator (310 in FIG. 3) is assigned to the spindle 125. At the second end 204 of the spindle 125, an assigned bearing element 232 of the two bearing elements 231, 232 is preferably secured on the spindle 125 by way of an additional fixing element 250 along the longitudinal extension 201 of the spindle 125. Preferably, the spindle 125 has, at its second end 204, a receptacle 212 for accommodating the additional fixing element 250.

Preferably, the spindle 125 has a magnet carrier 215. Preferably, the spindle 125 is connected to the magnet carrier 215. Here, the magnet carrier 215 is arranged on an outer circumference 211 of the spindle 125 and extends the spindle 125 in a radial direction 202 of the spindle 125. Preferably, the magnet carrier 215 is configured to be disc-shaped. According to FIG. 2, the magnet carrier 215 is formed in one piece with the spindle 125. On a side of the magnet carrier 215 facing the second end 204 of the spindle 125, a stop edge 219 is formed.

Preferably, at least one spring element 222, 223 is arranged, along the longitudinal extension 201 of the spindle 125, between the fixing element 221 and/or the additional fixing element 250 and a respectively assigned bearing element 231, 232 of the two bearing elements 231, 232. Two spring elements 222, 223 are arranged between the fixing element 221 and the bearing element 231. The spring element 222 has an outer diameter 225 and an inner diameter 227. The spring element 223 has an outer diameter 226. An inner diameter of the spring element 223 is preferably adapted to a diameter of the spindle 125. Preferably, the inner diameter 227 of the spring element 222 is greater than the outer diameter 226 of the spring element 223. The fixing element 221 and/or the additional fixing element 250 may, for example, be configured to be a snap ring.

FIG. 3 shows the spindle 125 of FIG. 1 and FIG. 2, which is supported by way of the bearing arrangement 200 of FIG. 2 in a stator 310 assigned to the drive unit 120 of FIG. 1. The stator 310 has, by way of example, a cylindrical base body 318 having an interior receptacle 311. The bearing arrangement 200 for supporting the spindle 125 is arranged in the interior receptacle 311.

Preferably, at least one of the two bearing elements 231, 232 is press-fitted onto the outer circumference 211 of the spindle 125, and/or at least one of the two bearing elements 231, 232 is press-fitted into a bearing seat 314, 315 associated with the interior receptacle 311. As a result, play between the spindle 125 and the assigned bearing element 231, 232 may be eliminated at least substantially, that is to say within customary manufacturing tolerances.

An upper bearing seat 314 is assigned to the bearing element 231 and a lower bearing seat 315 is assigned to the bearing element 232. Preferably, a bearing seat 315 assigned to the second, or free, end 204 of the spindle 125 in the interior receptacle 311 has an abutment surface 316 for abutting the bearing element 232 assigned to the bearing seat 315 along the longitudinal extension 201 of the spindle 125.

The bearing elements 231, 232 are preferably configured to be ball bearings. Here, the bearing element 231 preferably has an inner ring 266 and an outer ring 265. The outer ring 265 forms an outer circumference 261 of the bearing element 231 and the inner ring 266 forms an inner circumference 262 of the bearing element 231. Analogously thereto, the bearing element 232 preferably has an inner ring 268 and an outer ring 267. The outer ring 267 forms an outer circumference 263 of the bearing element 232 and the inner ring 268 forms an inner circumference 264 of the bearing element 232. The inner circumference 262 of the bearing element 231 and the inner circumference 264 of the bearing element 232 are arranged on the outer circumference 211 of the spindle 125. Furthermore, the outer circumference 261 of the bearing element 231 is arranged at the bearing seat 314 and the outer circumference 263 of the bearing element 232 is arranged at the bearing seat 315.

As described above, the spacer element 240 is arranged, by way of example, between the two bearing elements 231, 232. The spacer element 240 is preferably sleeve-shaped and has an interior receptacle 341. The interior receptacle 341 is arranged on the outer circumference 211 of the spindle 125. The outer ring 267 of the bearing element 232 abuts the abutment surface 316 of the interior receptacle 311 of the stator 310 along the longitudinal extension 201 of the spindle 125. Preferably, the inner ring 268 of the bearing element 232 rests, in sections in the circumferential direction, against the fixing element 250. Preferably, an end face 342 of the spacer element 240 facing the bearing element 232 rests against the bearing element 232. The end face 342 of the spacer element 240 rests against the inner ring 268 of the bearing element 232. Furthermore, an end face 344 of the bearing element 231 facing the spacer element 240 rests, by way of example, against an end face 343 facing the bearing element 231. The inner ring 266 of the bearing element 231 rests against the end face 343 of the spacer element 240.

Preferably, as described above, two spring elements 222, 223 are arranged between the fixing element 221 and the bearing element 231. Preferably, the spring elements 222, 223 are arranged coaxially with respect to one another. Alternatively or optionally, a spring element 222 is arrangeable between the lower bearing element 232 and the additional fixing element 250, or at a location 322, and/or a spring element 223 is arrangeable at a location 323. Preferably, at least one of the two spring elements 222, 223 is configured to be a wave spring. Tolerance compensation along the longitudinal extension 201 of the spindle 125 is preferably effected via the spring elements 222, 223.

At this point, it should be noted that the spring element 223, the spacer element 240, and the additional fixing element 250 may be dispensed with when both bearing elements 231, 232 are arranged on the spindle 125 by way of an interference fit between the inner circumference 262, 264 of the bearing elements 231, 232 and the outer circumference 211 of the spindle 125, since in this case the respective inner rings of the bearing elements 231, 232 are fixed relative to one another along the longitudinal extension 201 of the spindle 125 and the need for a corresponding tolerance compensation is eliminated.

Preferably, the interior receptacle 311 of the stator 310 has a fixing receptacle 312, which is configured to accommodate the fixing element 221. Preferably, the fixing element 221 is arranged in the fixing receptacle 312. As a result, the spindle 125 may be fixed by way of the fixing element 221 in the direction of its longitudinal extension 201, or in its axial direction, in the interior receptacle 311. The bearing element 231 preferably rests against the fixing element 221 and thus fixes the spindle 125 in the direction of its longitudinal extension 201, or in its axial direction, in the interior receptacle 311.

Furthermore, FIG. 3 illustrates the magnet carrier 215 of the spindle 125, which, along the radial direction 202 of the spindle 125, covers, by way of example, at least the interior receptacle 311. The magnet carrier 215 projects beyond the stator 310 in the radial direction 202 of the spindle 125. Preferably, the magnet carrier 215 has at least one recess 399 in order to enable access into the interior receptacle 311 of the stator 310. Preferably, the at least one recess 399 enables access to the fixing element 221 fixable in the fixing receptacle 312.

During assembly of the spindle 125 in the stator 310, arranging the fixing element 221 at a region of the spindle 125 facing the magnet carrier 215 preferably takes place first. Subsequently, the preferably two bearing elements 231, 232 and the spacer element 240 may be arranged on the outer circumference 211 of the spindle 125. Here, preferably at least one of the two bearing elements 231, 232 is press-fitted onto the outer circumference 211 of the spindle 125 and/or at least one of the two bearing elements 231, 232 is press-fitted into a bearing seat 314, 315 assigned to the interior receptacle 311. Thereafter, arranging the spindle 125 in the interior receptacle 311 of the stator 310 preferably takes place. Finally, the fixing element 221 may be arranged in the fixing receptacle 312 of the stator 310. Here, by way of a tool through the recess 399 of the magnet carrier 215, the fixing element 221 is preferably moved from the region of the spindle 125 facing the magnet carrier 215 into the fixing receptacle 312. Preferably, before arranging the bearing elements 231, 232 and the spacer element 240 on the spindle 125, the additional fixing element 250 is arranged or secured in the receptacle 212 at the end 204 of the spindle 125.

A force flow through the bearing elements 231, 232 is illustrated by way of an arrow 301. Preferably, the force flow applied at the fixing element 221 takes place through the spring element 222, which preferably has a larger inner diameter 227 than the spring element 223. Here, the force flow is preferably not compensated by the spring element 223. Rather, the force flow is preferably guided by the spring element 222 into the outer ring 265 of the upper bearing element 231. At the inner ring 266 of the bearing element 231, the force flow is preferably guided via the end face 343 of the spacer element 240 facing the bearing element 231 into the spacer element 240. Via the end face 342 facing the lower bearing element 232, the force flow is preferably guided into the inner ring 268 of the bearing element 232. Alternatively thereto, the force flow may be guided via the upper interference fit between the inner circumference 262 of the inner ring 266 and the outer circumference 211 of the spindle 125 and via the lower interference fit between the outer circumference 211 of the spindle and the inner circumference 264 of the inner ring 268. Finally, the force flow is preferably dissipated via the outer ring 267 of the bearing element 232 into the stator 310.

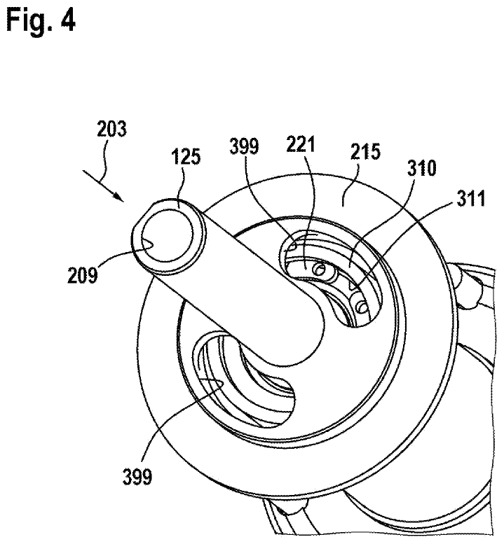

FIG. 4 shows the spindle 125 having the magnet carrier 215, as well as the stator 310 of FIG. 3, as viewed from the first end 203. FIG. 4 illustrates the at least one, illustratively two recesses 399, of the magnet carrier 215 for engagement into the interior receptacle 311 of the stator 310 for positioning the fixing element 221 in the fixing receptacle 312 of the interior receptacle 311 of FIG. 3. The recesses 399 are at least approximately arcuate. By way of example, the two recesses 399 are arranged diametrically opposite one another.

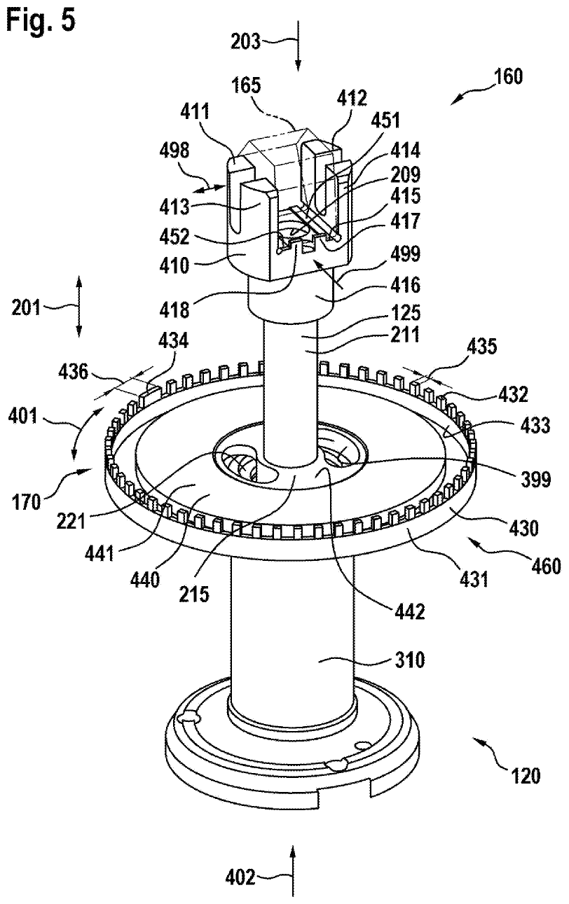

FIG. 5 shows the spindle 125 having the stator 310 of FIG. 1 to FIG. 4 and the beam deflector 165 of FIG. 1. The drive unit 120 of FIG. 1 preferably has the stator 310 and a rotor 460 for rotatably driving the spindle 125. Preferably, the drive unit 120 is configured to be a spindle motor. Here, the drive unit 120 is preferably configured to be a brushless DC motor.

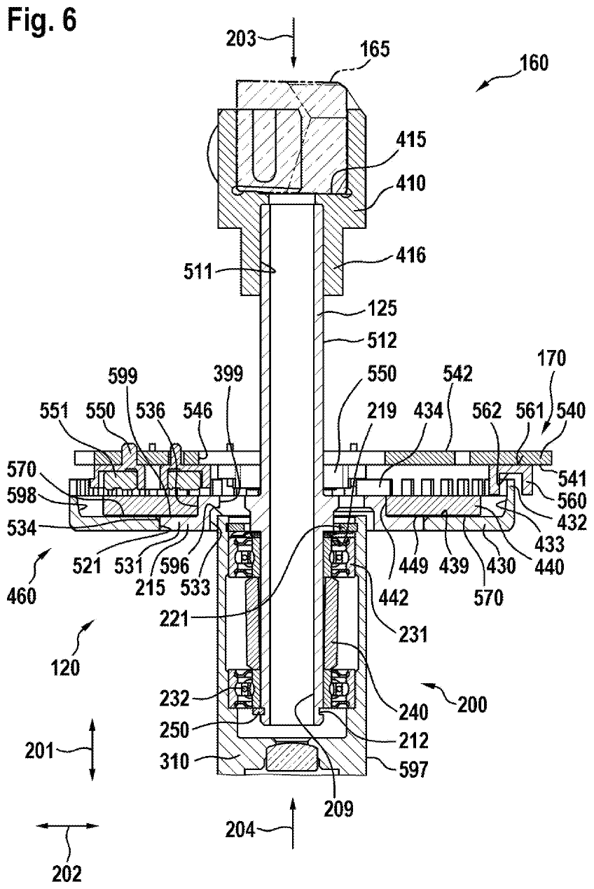

A magnetic disc 440 is, by way of example, assigned to the rotor 460 and two coils (551 in FIG. 6) are, by way of example, assigned to the stator 310. By energization of the coils (551 in FIG. 6), the spindle 125 may be set into rotation or subjected to a holding torque for static positioning.

The laser diode 135 of FIG. 1 is preferably arranged at an end 402 of the stator 310 facing away from the beam deflector 165. A laser beam generated by the laser diode 135 is guided along the interior recess 209 of the spindle 125 toward the beam deflector 165. The laser beam is deflected by the beam deflector 165. Preferably, the beam deflector 165 is configured to be a pentaprism. A pentaprism, also pentagonal prism, is understood to mean a five-sided optical prism. Here, two of the five surfaces are used as internal reflection surfaces. Preferably, the laser beam is deflected in a perpendicular direction. Thus, by rotation of the spindle 125, an associated plane may be projected upon deflection of the laser beam. Furthermore, the beam deflector 165 may be configured to be a beam splitter, which splits the laser beam generated by the laser diode 135 into a parallel laser beam, emitted upward along the longitudinal extension 201, and a perpendicular laser beam.

Preferably, the determination unit 170 of FIG. 1 is assigned to the spindle 125. The determination unit 170 has, by way of example, a toothed disc 430 and a photointerrupter (560 in FIG. 6). The toothed disc 430 has a base body 431. Preferably, the base body 431 is configured in a shell shape having a receptacle 433. Preferably, the receptacle 433 is configured to at least partially receive the magnetic disc 440. Preferably, the toothed disc 430 has teeth 432 arranged distributed in the circumferential direction 401. The teeth 432 are formed on an outer circumference of the toothed disc 430 along the longitudinal extension 201 of the spindle 125.

Preferably, the determination unit 170 has a reference mark 434 as an absolute reference. The reference mark 434 is preferably assigned to the toothed disc 430. The reference mark 434 may, for example, be configured as a reference tooth or a reference recess. Here, the teeth 432 of the toothed disc 430 have a first width 435, and the reference tooth 434 or the reference recess has a second width 436. The second width 436 is preferably greater than the first width 435.

The magnetic disc 440 preferably has a base body 441 that is at least in sections annular. The annular base body 441 preferably has an interior receptacle 442. The interior receptacle 442 is preferably arranged on the inner shoulder (536 in FIG. 6) of the magnet carrier 215 of the spindle 125. Alternatively, the magnetic disc 440 may comprise at least two magnet parts. Preferably, the magnetic disc 440 is configured to be a permanent magnet having N pole pairs. The magnet carrier 215 of the spindle 125 and the toothed disc 430 may be formed in one piece.

At its end 203 facing away from the stator 310, the spindle 125 has the rotating head 160 having the beam deflector 165. The beam deflector 165 has, by way of example, a bracket 410, by way of which it is arranged at the end 203 of the spindle 125. For this purpose, the bracket 410 preferably has a fastening section 416 for arrangement at the first end 203 of the spindle 125. Preferably, the fastening section 416 is formed in one piece with the bracket 410. Alternatively, the fastening section 416 may be connected to the bracket 410. The fastening section 416 is arranged on the outer circumference 211 of the spindle 125. Preferably, the fastening section 416 is connected to the spindle 125. Furthermore, the bracket 410 has at least two, illustratively four receptacle elements 411, 412, 413, 414, which form a preferably central receptacle 415. The beam deflector 165 is preferably receivable in the receptacle 415. The beam deflector 165 is accommodated in the receptacle 415. Here, the at least two receptacle elements 411, 412, 413, 414 are preferably configured to mechanically fix the beam deflector 165 in the receptacle 415.

Preferably, the at least two receptacle elements 411, 412, 413, 414 are configured as webs extending along the longitudinal extension 201 of the spindle 125. The receptacle elements 411, 412, 413, 414 are preferably arranged facing away from the spindle 125. The at least two receptacle elements 411, 412, 413, 414 are formed in one piece with the bracket 410. Alternatively, the at least two receptacle elements 411, 412, 413, 414 may be connected to the bracket 410.

The receptacle 415 preferably has at least one, illustratively two positioning surfaces 451, 452 for positioning the beam deflector 165. The positioning surfaces 451, 452 are preferably arranged on a bottom surface facing the spindle 125. At least one end face 499 of the two positioning surfaces 451, 452, at least one, illustratively two stops 417, 418 may be formed. The stops 417, 418 are, by way of example, formed in the longitudinal extension 201 of the spindle 125 and form a stop edge for the beam deflector 165. Preferably, the receptacle elements 411, 412, 413, 414 and/or the stops 417, 418 are formed in one piece with the bracket 410. Preferably, the receptacle elements 411, 412, 413, 414 and/or the stops 417, 418 are connected to the bracket 410 via a connection.

Two receptacle elements 411, 413 are arranged to the left of the beam deflector 165 and two receptacle elements 412, 414 are arranged to the right of the beam deflector 165. Preferably, the left receptacle elements 411, 413 and the right receptacle elements 412, 414 are spaced apart from one another in a transverse direction 498 relative to the end face 499. Alternatively or optionally, the beam deflector 165 is fixed in the receptacle 415 by way of at least one adhesive bond.

FIG. 6 shows the drive unit 120 having the spindle 125, the stator 310, the rotor 460, the beam deflector 165, and the determination unit 170 of FIG. 5. FIG. 6 illustrates a photointerrupter 560 assigned to the determination unit 170. The photointerrupter 560 is preferably provided for determining a relative change of an angular position of the spindle 125 in the circumferential direction 401 of FIG. 5.

Preferably, the photointerrupter 560 is configured to be a quadrature encoder. Such a quadrature encoder preferably comprises two photointerrupters, which are preferably arranged with a circumferential offset 401 shown in FIG. 4 by half a tooth width or half a first width 435 relative to one another. Alternatively, the offset may amount to half a tooth width plus an integer multiple of the tooth width. By measuring a tooth pattern assigned to the toothed disc 430 at two positions having a phase offset of, by way of example, 90°, the rotational direction may be determined stepwise. A common light source is preferably assigned to the preferably two photointerrupters. Furthermore, two preferably separate photodiodes or phototransistors are assigned to the preferably two photointerrupters.

The photointerrupter 560 has a bottom surface 561 and a preferably U-shaped receptacle 562. In the U-shaped receptacle 562, the teeth 432 of the toothed disc 430 are preferably received at least in sections. The bottom surface 561 of the photointerrupter 560 is arranged on a bottom side 541 of a printed circuit board 540 facing the toothed disc 430.

The printed circuit board 540 is preferably arranged in the housing 110 of the rotary laser 100 of FIG. 1. Here, the printed circuit board 540 is preferably arranged parallel to the toothed disc 430. By way of example, the printed circuit board 540 has an interior recess 546 for coaxial arrangement on the spindle 125. The printed circuit board 540 has a top side 542 arranged facing the beam deflector 165 and the bottom side 541 arranged facing the toothed disc 430. Preferably, the printed circuit board 540 has two coils 551. The coils 551 are arranged on the bottom side 541 of the printed circuit board 540. Preferably, the coils 551 are arranged on the printed circuit board 540 by way of coil brackets 550. Preferably, the coil holders 550 are fixed on the printed circuit board 540.

The interior recess 442 of the magnetic disc 440 is arranged on an inner shoulder 536 of the magnet carrier 215. As a result, centering of the magnetic disc 440 may be effected in a simple manner. The magnet carrier 215 preferably has a circumferential collar 531, which extends the magnet carrier 215 in the radial direction. Furthermore, the magnetic disc 440 rests against the circumferential collar 531 along the longitudinal extension 201 of the spindle 125, or the magnetic disc 440 rests at least in sections on an top side 599 of the circumferential collar 531 facing the beam deflector 165.

Preferably, the toothed disc 430 has an interior recess 521, which is arranged on an outer circumference 534 of the circumferential collar 531. Preferably, the receptacle 433 and the circumferential collar 531, or the top side 599 of the circumferential collar 531, form a receptacle 598 for accommodating the magnetic disc 440. Furthermore, the magnet carrier 215 has an interior receptacle 533 facing the stator 310. Preferably, the interior receptacle 533 is configured to receive the stator 310 in sections. Preferably, the stator 310 is arranged coaxially with the interior receptacle 533. Here, an outer circumference 597 of the stator 310 is preferably spaced apart in the radial direction 202 from the interior receptacle 533. Furthermore, an end face 596 of the stator 310 facing the magnet carrier 215 is preferably spaced apart from the magnet carrier 215. Thus, the stator 310 may be arranged in the housing 110 of the rotary laser 100 of FIG. 1 and the spindle 125 may rotate without collision with the magnet carrier 215, while at the same time a compact arrangement of the stator 310 and the magnet carrier 215 having the circumferential collar 531 may be enabled.

Preferably, the magnetic disc 440 is fixed in the receptacle 598 or 433 by way of a material bond. Preferably, an adhesive 570 for the formation of the material bond, by way of example, is arranged between an bottom side 449 of the magnetic disc 440, by way of example, assigned to the magnetic disc 440 and facing the toothed disc 430, and a bottom surface 439 of the toothed disc 430, facing the magnetic disc 440. As a result, the toothed disc 430 may also be fixed on the circumferential collar 531 of the magnet carrier 215. The adhesive 570 may, for example, be configured as double-sided adhesive tape for forming the material bond.

Furthermore, FIG. 6 illustrates an interior receptacle 511 assigned to the fastening section 416 of the bracket 410. The interior receptacle 511 is preferably configured for arrangement on the outer circumference 211 of the spindle 125. Preferably, the spindle 125 has, at its upper end 203, a receptacle 512 which is arrangeable in the interior receptacle 511 of the bracket 410. The interior receptacle 511 has a diameter assigned to the outer circumference 211 of the receptacle 512 of the spindle 125.

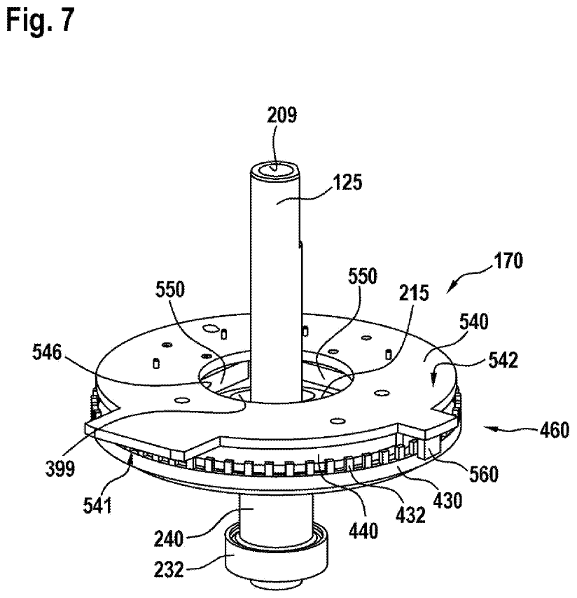

FIG. 7 shows the spindle 125 with the rotor 460, that is to say the toothed disc 430, the magnetic disc 440, and the printed circuit board 540 with the two coil brackets 550 of FIG. 6. FIG. 7 illustrates the coaxial arrangement of the printed circuit board 540 relative to the spindle 125. Through the interior recess 546 of the printed circuit board 540 and the at least one recess 399 of the magnet carrier 215 of the spindle 125, the fixing element 221 of FIG. 2 to FIG. 6 may be arranged for fixing in the stator 310 of FIG. 3 to FIG. 6 in the fixing receptacle 312 of FIG. 3.

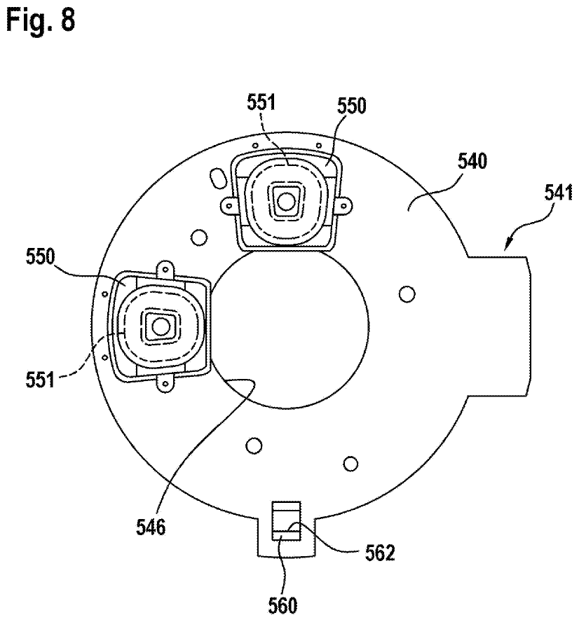

FIG. 8 shows the printed circuit board 540 of FIG. 5 and FIG. 6 as viewed from its bottom side 541. As described above, preferably two coils 551 are arranged on the bottom side 541 of the printed circuit board 540 by way of a coil bracket 550. Furthermore, the photointerrupter 560 is preferably arranged on the bottom side 541 of the printed circuit board 540. The two coils 551 are arranged offset from one another by 90°. Preferably, the photointerrupter 560 is arranged opposite one of the two coils 551, or offset therefrom by 180°.

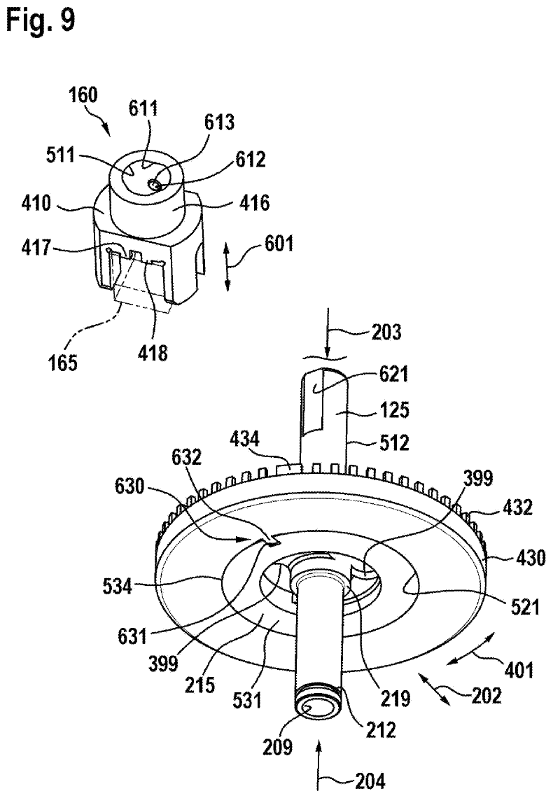

FIG. 9 shows the spindle 125 of FIG. 1 to FIG. 8 having the toothed disc 430 and the beam deflector 165 of FIG. 5 and FIG. 6. According to FIG. 9, the toothed disc 430 preferably has at least one first positive-locking element 632 at its interior recess 534, and the circumferential collar 531 of the magnet carrier 215 of the spindle 125 has at least one second positive-locking element 631 at its outer circumference 534. The at least one first positive-locking element 632 and the at least one second positive-locking element 631 form, by way of example, a positive-locking connection 630.

The first positive-locking element 632 of the toothed disc 430 is configured as an extension in the radial direction 202 of the spindle 125 and the second positive-locking element 631 of the magnet carrier 215 is configured as a recess in the radial direction 202 of the spindle 125. Alternatively, the second positive-locking element 631 of the magnet carrier 215 is configured as an extension in the radial direction 202 of the spindle 125 and the first positive-locking element 632 of the toothed disc 430 is configured as a recess in the radial direction 202 of the spindle 125. Furthermore, the toothed disc 430 and the magnet carrier 215 may also comprise a plurality of first and second positive-locking elements 632, 631 arranged distributed in the circumferential direction 401 of the spindle 125.

Preferably, the spindle 125 has a flattened portion 621 at the first end 203 for positioning the beam deflector 165. The flattened portion 621 is preferably arranged on the receptacle 512 of the spindle 125. As described above, the bracket 410 of the beam deflector 165 preferably has the fastening section 416 having the corresponding interior receptacle 511. Preferably, the interior receptacle 511 of the fastening section 416 has a flattened portion 611 assigned to the flattened portion 621 of the spindle 125. Preferably, the flattened portion 611 of the interior receptacle 511 of the bracket 410 has a recess 613, in which a clamping element 612 is arranged. The recess 613 is formed in the radial direction 601 of the interior receptacle 511. Preferably, the recess 613 is configured to be a threaded recess, and the clamping element 612 is a screw, in particular a grub screw.

If the bracket 410 of the beam deflector 165, or the interior receptacle 511, is arranged on the receptacle 512 of the spindle 125, the two flattened portions 621, 611 are preferably arranged abutting one another. Thus, defined positioning of the bracket 410, in particular of the beam deflector 165, on the spindle 125 may be achieved. By screwing in the threaded pin 612, the threaded pin 612 may be biased against the flattened portion 621 of the spindle 125, and the bracket 410 may thus fix the beam deflector 165 to the spindle 125.

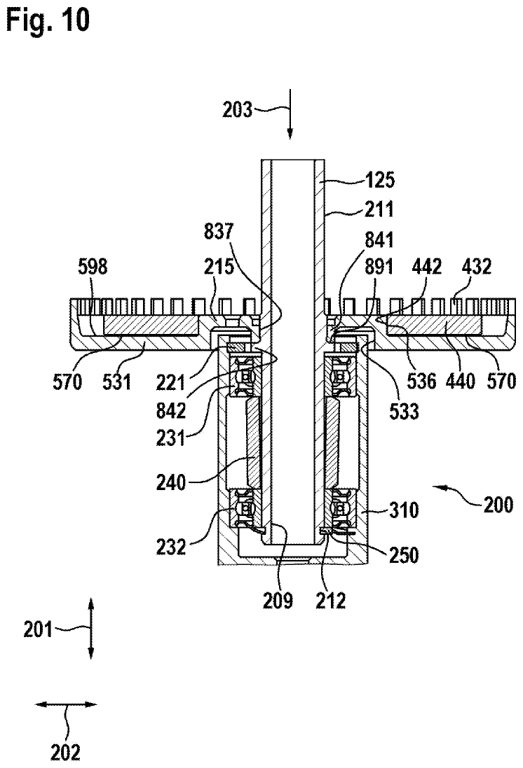

FIG. 10 shows the spindle 125 of FIG. 1 to FIG. 9, which is supported in the stator 310 by way of the bearing arrangement 200 of FIG. 2, FIG. 3, and FIG. 6, as well as having the toothed disc 430 of FIG. 5 to FIG. 7 and FIG. 9. The toothed disc 430 of FIG. 10 is formed in one piece with the magnet carrier 215 of FIG. 2 to FIG. 6 and FIG. 9. For this purpose, the magnet carrier 215 preferably has a bearing section 841 having an interior receptacle 837. The interior receptacle 837 is arranged, by way of example, on the outer circumference 211 of the spindle 125. To secure the position of the toothed disc 430 or the magnet carrier 215, the spindle 125 preferably has a circumferential collar 842 along its longitudinal extension 201. The bearing section 841 is positioned to secure the tooth disc 430 in place, preferably along the longitudinal extension 201 of the spindle 125, on a side 891 facing the first end 203 of the spindle 125.

Preferably, the toothed disc 430 of FIG. 10 forms the receptacle 598 for accommodating the magnetic disc 440. Preferably, the interior receptacle 442 of the magnetic disc 440 is arranged on the inner shoulder 536 of the magnet carrier 215, wherein the inner shoulder 536, according to the one-piece configuration of the toothed disc 430 and the magnet carrier 215, is assigned to the toothed disc 430. Analogously to FIG. 6, the magnetic disc 440 is preferably fixed in the receptacle 598 by way of an adhesive bond having the adhesive 570.

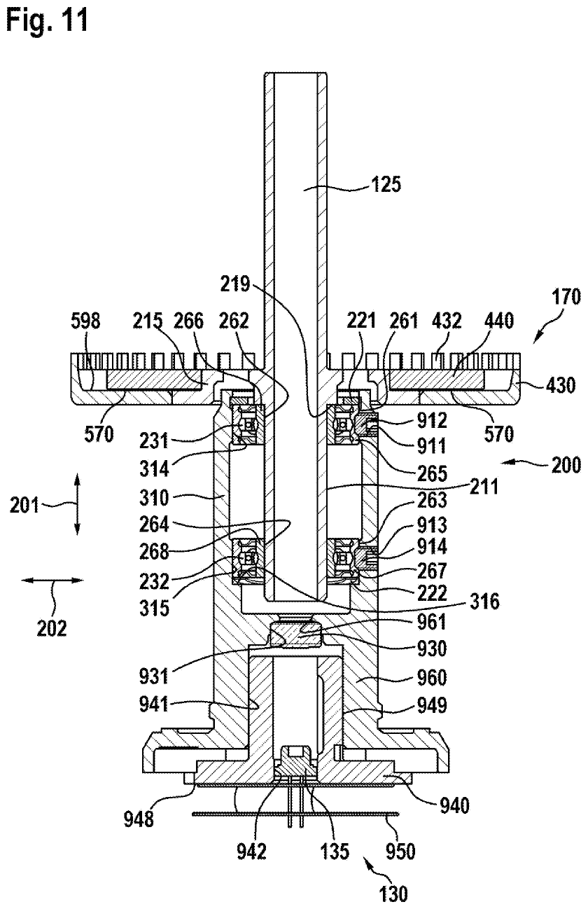

FIG. 11 shows the spindle 125 of FIG. 1 to FIG. 10 having the stator 310 of FIG. 3 to FIG. 6 and FIG. 10. Preferably, the stator 310 has at least one recess 911, 913, which is arranged perpendicularly to the interior receptacle 311. The at least one recess 911, 913 is arranged along the longitudinal extension 201 of the spindle 125 in the region of at least one bearing seat 314, 315. Preferably, a clamped connection is formed between a clamping element 912, 914 assigned to one of the at least one recesses 911, 913 and an outer circumference 261, 263 of one of the two bearing elements 231, 232. By way of example, a first clamped connection is formed between the outer circumference 261 of the upper bearing element 231 and the clamping element 912, and a second clamped connection is formed between the outer circumference 263 of the lower bearing element 232 and the clamping element 914. By way of example, the clamping elements 912, 914 are configured to be screws, in particular, grub screws. By way of the clamping elements 912, 914, play between the stator 310 and the assigned bearing element 231, 232 may be eliminated at least substantially, that is to say within customary manufacturing tolerances.

Furthermore, FIG. 11 illustrates the laser unit 130 of FIG. 1. The laser unit 130 has, for example, a laser module housing 960 having an interior receptacle 961 for outputting or emitting a collimated laser beam generated by the laser diode 135. The laser module housing 960 may be formed in one piece with the stator 310.

For collimation of the laser beam, the laser unit 130 preferably has a collimation lens 930. Here, the collimation lens 930 is preferably arranged, and preferably fixed, in an upper receptacle section 931 of the interior receptacle 961 of the laser module housing 960. The collimating lens 930 is preferably secured in the interior receptacle 961 or the receptacle section 931 by way of a material bond and/or a press-fit.

Furthermore, a laser diode holder 940 is arranged in the interior receptacle 961, in particular, in a lower receptacle section 941. Preferably, a press-fit is formed, at least in sections, between an outer circumference 949 of the laser diode holder 940 and the receptacle section 941. Alternatively, the laser diode holder 940 may be fixed in the interior receptacle 961, or the receptacle section 941, via a material bond.

The laser diode holder 940 illustratively has an interior receptacle 942. In the interior receptacle 942, the laser diode 135 for generating a laser beam is preferably arranged. The laser diode 135 is preferably arranged on a printed circuit board 950. Preferably, the printed circuit board 950 is configured to be a flexible circuit board. The printed circuit board 950 is arranged on a bottom side 948 of the laser diode holder 940 facing away from the stator 310. Preferably, the printed circuit board 950 is fixed on the laser diode holder 940 by way of a material bond. According to one embodiment, the material bond is an adhesive bond. Here, the adhesive is preferably double-sided adhesive tape.

Preferably, a monitor diode is assigned to the laser diode 135. The monitor diode is preferably configured to measure a laser output assigned to the laser diode 135. Here, the monitor diode may be a monitor diode integrated into the laser diode 135. Preferably, the laser unit 130 has a photodiode, not shown, which is provided for measuring the laser output independently of the monitor diode.

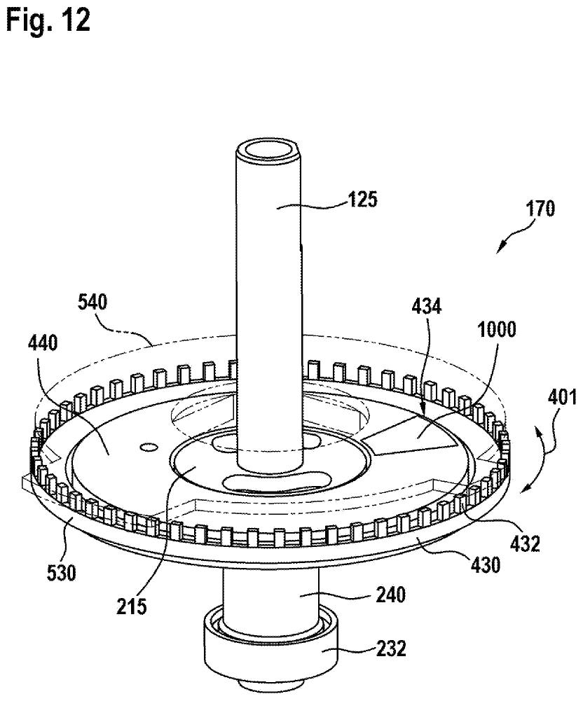

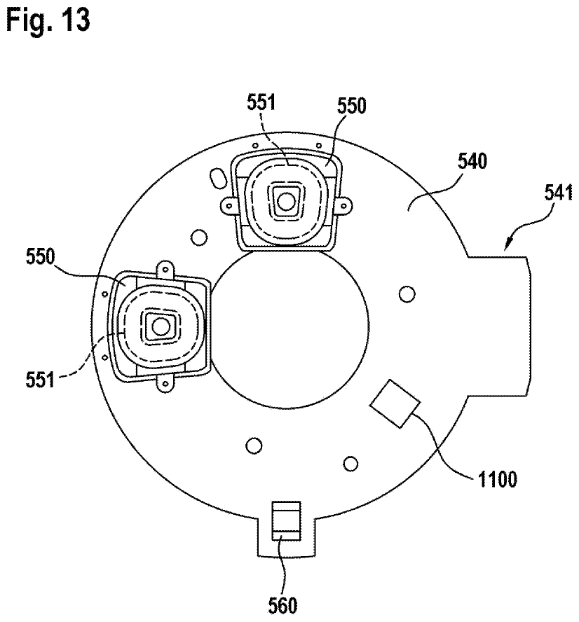

FIG. 12 shows the spindle 125 of FIG. 1 to FIG. 11 having the toothed disc 430, the magnetic disc 440, as well as the printed circuit board 540, which is shown transparently for improved illustration. The toothed disc 430 according to FIG. 12 has only the teeth 432 having the first width 435 arranged distributed on the outer circumference. The reference mark 434 is configured as a positioning feature 1000 on the magnetic disc 440 and is operatively connected to an absolute encoder (1100 in FIG. 13).

Here, a mechanically defined alignment of the beam deflector 165, the magnetic disc 440, and the toothed disc 430 relative to one another is not required. Absolute positioning is preferably achieved by way of an additional component, for example a reflective light sensor, here, by way of example, in the form of an absolute encoder (1100 in FIG. 11) on the printed circuit board 540 and a positioning feature 1000 on the magnetic disc 440. The positioning feature 1000 is preferably a reflective or light-absorbing sticker.

The positioning feature 1000 is preferably configured to identify one of the pole pairs of the magnetic disc 440. If the magnetic disc 440 comprises N pole pairs, the positioning feature 1000 must permit identification of an angular range having a width smaller than 360°/N. Preferably, the positioning feature 1000 has a width of 180°/N in the circumferential direction 401 of the spindle 125. Within each respectively identified pole pair, exact position ascertainment is achieved via the electrical angle of a magnetic field generated by the coils 551 in FIG. 6 and FIG. 8. The ascertainment of this angle is preferably achieved in the manufacturing process by arbitrary angular positioning of the spindle 125 by way of the coil field within the positioning feature 1000.

FIG. 13 shows the printed circuit board 540 of FIG. 5, FIG. 6, and FIG. 12 as viewed from its bottom side 541 facing the magnetic disc 440. As described above, preferably two coils 551 are arranged on the bottom side 541 of the printed circuit board 540 by way of a coil holder 550. Furthermore, the photointerrupter 560 is arranged on the bottom side 541 of the printed circuit board 540. Furthermore, an absolute encoder 1100 assigned to the positioning feature 1000 of FIG. 12 is arranged, by way of example, on the bottom side 541 of the printed circuit board 540.

FIG. 14A to FIG. 14C show an exemplary calibration process 1200 of the positioning feature 1000 of FIG. 12 of the magnetic disc 440 and of the absolute encoder 1100 of FIG. 11 assigned to the printed circuit board 540. FIG. 14A to FIG. 14C visualize, by way of example, a magnetic pole 1240 (FIGS. 14A and 14B) of the magnetic disc 440, a laser beam 1210 deflected at the beam deflector 165, and a main axis 1230 along which the laser beam 1210 is to be oriented. By way of example, five magnetic poles 1240 are shown.

In FIG. 14A, by way of example, the coil field of the coils 551 of FIG. 13 orients a magnetic field of the magnetic disc 440 along the main axis 1230, wherein the positioning feature 1000 and the beam deflector 165 are arranged in an arbitrary position. Here, the laser beam 1210 is spaced apart from the main axis 1230 by an angle 1220. By way of example, the laser beam 1210 is arranged to the left of the main axis 1230 by the angle 1220.

In FIG. 14B, the coil field has been rotated until the laser beam 1210 lies on the main axis 1230. This is preferably detected by a suitable detection device sufficiently known to the person skilled in the art. A first angle assigned to the coil field is then preferably stored.

In FIG. 14C, the coil field is preferably further rotated until the absolute encoder 1100 lies within the positioning feature 1000. The absolute encoder 1100 is arranged centrally within the positioning feature 1000. Here, the laser beam 1210 is preferably spaced apart from the main axis 1230 by an angle 1209. The laser beam 1210 is arranged to the right of the main axis 1230 by the angle 1209.

A second angle assigned to the coil field is then preferably stored. The second angle preferably defines the position of the positioning feature 1000 within a pole pair, or magnetic pole 1240. The angle difference between the first and second angle preferably defines the coil field path from the positioning feature 1000 to the sought laser position.

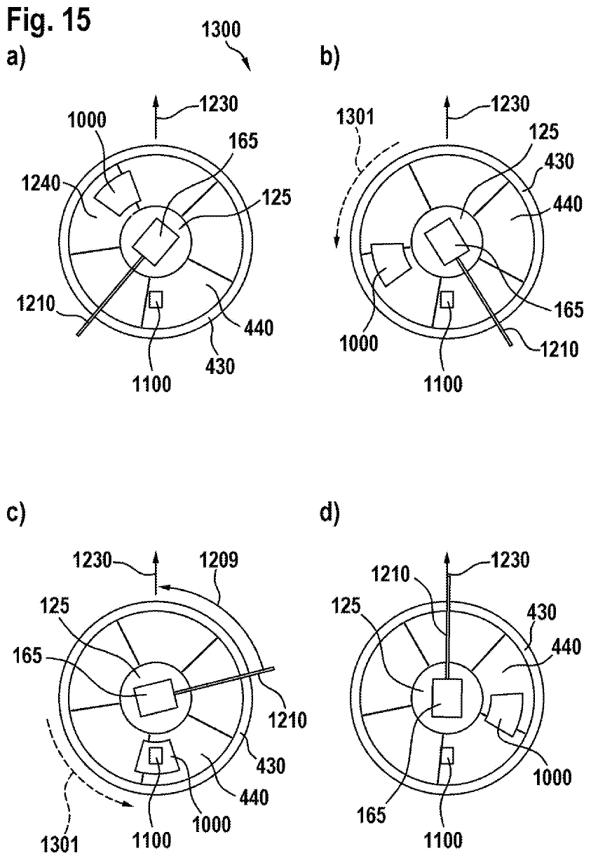

FIG. 15A to FIG. 15D show an exemplary absolute positioning process 1300 at a start of the rotary laser 100 of FIG. 1 based on the calibration process 1200 according to FIG. 14A to FIG. 14C.

In FIG. 15A, by way of example, the coil field of the coils 551 of FIG. 13 orients the magnetic field of the magnetic disc 440 along the second angle according to FIG. 14C. Preferably, the absolute position is ascertained exactly up to an angular section of a pole pair.

In FIG. 15B, the coil field is, by way of example, rotated in the direction of an arrow 1301. The coil field is preferably rotated by 360°/N, that is to say by one pole pair, or magnetic pole 1240 (FIG. 15A), until the absolute encoder 1100 detects the positioning feature 1000. In particular, the coil field is preferably rotated by one pole pair up to N−1 times, that is to say one time fewer than the number of pole pairs.

In FIG. 15C, the spindle 125 is now, by way of example, in an absolute position W2, or the position according to FIG. 14C. Subsequently, the coil field is preferably rotated by the angle difference of the first and second stored angles determined according to FIG. 14A and FIG. 14A.

In FIG. 15D, the laser beam 1210 is oriented along the main axis 1230. In this position, the photointerrupter 560 of FIG. 13 is preferably reset.

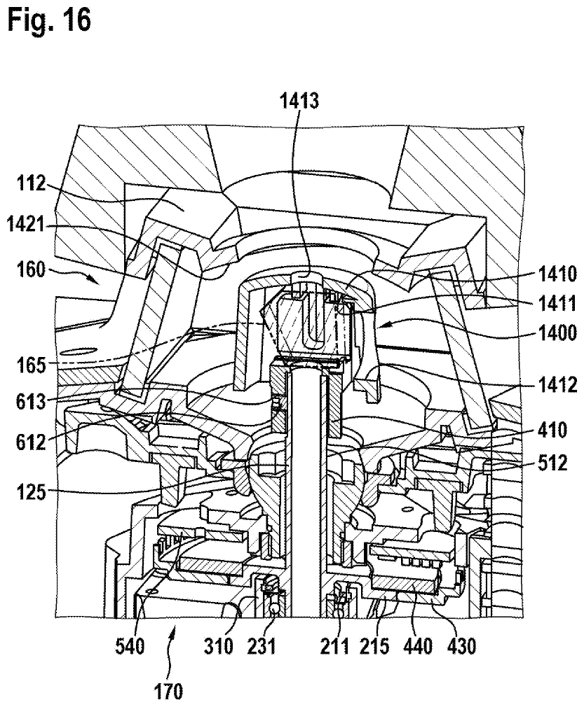

FIG. 16 shows the housing 110 having the rotary head 160, or the beam deflector 165, and the spindle 125 of FIG. 1 to FIG. 15D. FIG. 16 illustrates the cage 112 assigned to the rotary head 160, which is preferably configured for protection against an impact of the rotary head 160. The cage 112 preferably forms an upper part of the housing 110 of FIG. 1. Preferably, the cage 112 is assigned to the bracket 410 of the beam deflector 165. Here, the cage 112 forms an interior receptacle 1421 for accommodating the beam deflector 165. Preferably, the cage 112 has metal and/or plastic.

By way of example, a cap 1400 is assigned to the bracket 410. The cap 1400 is preferably configured as an additional protective measure for protection against an impact of the beam deflector 165 against the housing 110, or the cage 112. Here, the cap 1400 fixes the beam deflector 165 on the holder 410. The cap 1400 has, by way of example, a base body 1410 having an interior receptacle 1411 for accommodating the bracket 410. Preferably, the base body 1410 is configured to be at least approximately cylindrical. Preferably, the cap 1400, or the base body 1410, has an upper recess 1413. Furthermore, the cap 1400, or the base body 1410, preferably has a right receptacle 1412. The receptacle 1412 is preferably assigned to accommodate wedge prism (1520 in FIG. 15A) assigned to the beam deflector 165.

Preferably, the cap 1400 is fastened to the bracket 410 by way of a clamped connection or a latching connection. Preferably, the cap 1400 has plastic.

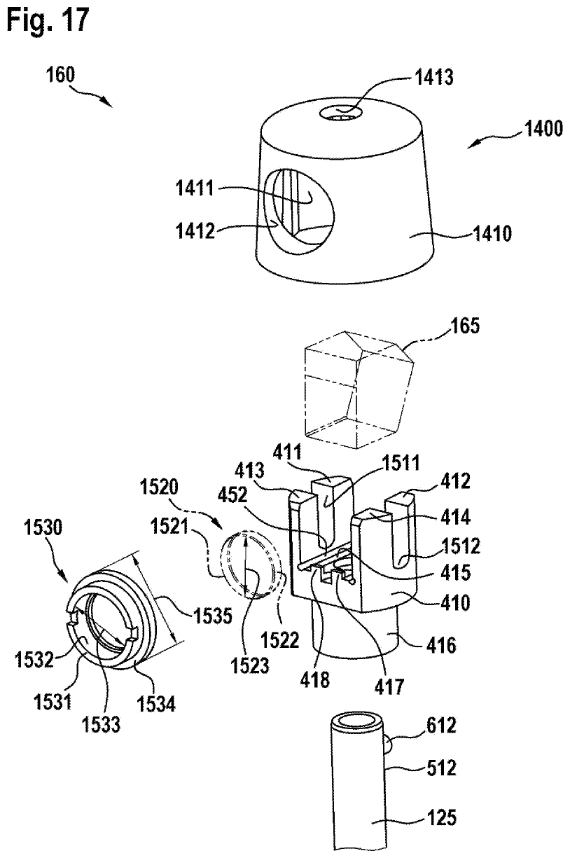

FIG. 17 shows the rotary head 160 having the spindle 125, the bracket 410, the beam deflector 165, and the cap 1400 of FIG. 16. Preferably, a wedge prism 1520 is assigned to the beam deflector 165. Preferably, the wedge prism 1520 has a disc-shaped base body 1521 having an outer circumference 1522 and a diameter 1523.

Preferably, a wedge prism bracket 1530 is assigned to the wedge prism 1520. The wedge prism bracket 1530 has, by way of example, an annular base body 1531 having an interior receptacle 1532 having an inner diameter 1533. Furthermore, the base body 1531 has a circumferential collar 1534, which extends the base body 1531 in the radial direction and has an outer diameter 1535. Preferably, the lateral receptacle 1412 of the cap 1400 is configured to accommodate the wedge prism 1520.

Furthermore, FIG. 17 illustrates the receptacle elements 411, 412, 413, 414 assigned to the bracket 410 of the beam deflector 165. A recess 1511 is formed between the receptacle elements 411, 413 and/or a recess 1512 is formed between the receptacle elements 412, 414. The two recesses 1511, 1512 are preferably each arranged transversely, in particular, perpendicularly, to the two positioning surfaces 451, 452.

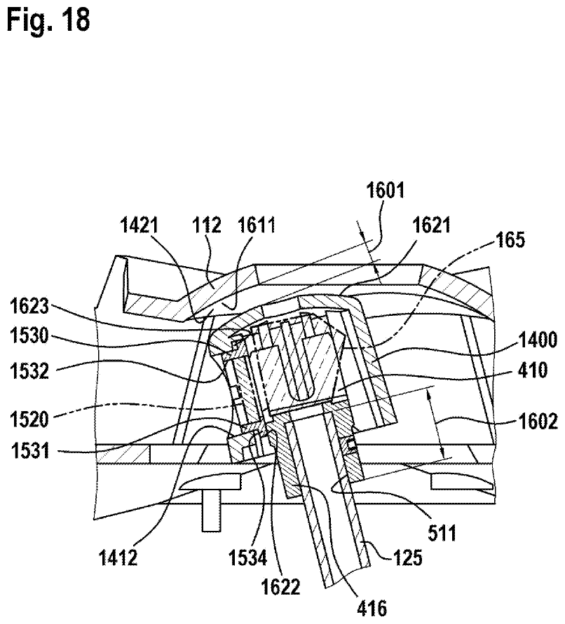

FIG. 18 shows the cage 112 having the interior receptacle 1421 of FIG. 16, which has an inner surface 1611 facing the beam deflector 165, as well as the beam deflector 165 having the cap 1400 of FIG. 16 and FIG. 17, and the spindle 125 of FIG. 1 to FIG. 7, FIG. 9 to FIG. 12, and FIG. 14A to FIG. 17. Preferably, the interior receptacle 1611 is configured to be arcuate such that, upon pivoting of the beam deflector 165, an impact against the interior receptacle 1611 may be prevented.

Preferably, a distance 1601 is formed between the inner surface 1611 of the cage 112 and a surface 1621 of the cap 1400 assigned to the bracket 410. Furthermore, the interior receptacle 511 of the bracket 410 has a depth 1602. The distance 1601 is preferably smaller than the depth 1602 of the interior receptacle 511.

Furthermore, FIG. 18 illustrates the exemplary arrangement of the wedge prism 1520 by way of the wedge prism bracket 1530 on the cap 1400. Preferably, the wedge prism bracket 1530 is arranged in the receptacle 1412 of the cap 1400. Preferably, the receptacle 1412 widens into the receptacle 1622 via a stop edge 1623. Preferably, the circumferential collar 1534 of the wedge prism bracket 1530 is arranged in the receptacle 1622 and abuts the stop edge 1623. The base body 1531 of the wedge prism bracket 1530 is arranged, for example, in the receptacle 1412. The wedge prism 1520 is preferably arranged in the interior receptacle 1532 of the base body 1531.

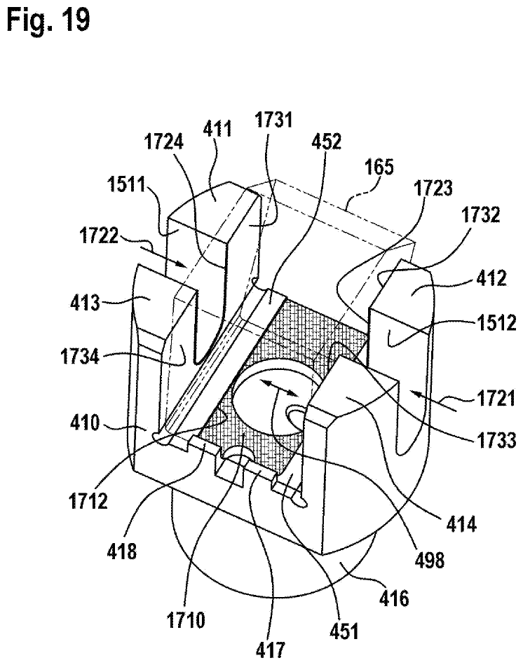

FIG. 19 shows the bracket 410 having the beam deflector 165 of FIG. 17. Preferably, along the transverse direction 498 of the two positioning surfaces 451, 452, an adhesive receptacle 1712 for accommodating a first adhesive 1710 is arranged between the two positioning surfaces 451, 452. Preferably, the adhesive receptacle 1712 has a receptacle height of 0.2 mm along the longitudinal extension 201 of the spindle 125. As a result, a capillary effect may be generated. Preferably, the first adhesive 1710 forms a planar adhesive bond.

Furthermore, in at least one, preferably in both recesses 1511, 1512, which are transverse, in particular, perpendicular, to the two positioning surfaces 451, 452 and are arranged between a first receptacle element 411, 412 and a second receptacle element 413, 415, a second adhesive 1723, 1724 is preferably arranged for forming a second adhesive bond 1721, 1722. Here, the adhesive bond 1721 is formed in the recess 1512 and/or the adhesive bond 1722 in the recess 1511. Preferably, the second adhesive bond 1723, 1724 is a fillet adhesive bond.

Furthermore, a side 1731 of the receptacle element 411 facing the beam deflector 165 and/or a side 1734 of the receptacle element 413 facing the beam deflector 165 form, by way of example, a left abutment surface of the beam deflector 165. Preferably, a side 1732 of the receptacle element 412 facing the beam deflector 165 and/or a side 1733 of the receptacle element 414 facing the beam deflector 165 form, for example, a right abutment surface of the beam deflector 165.

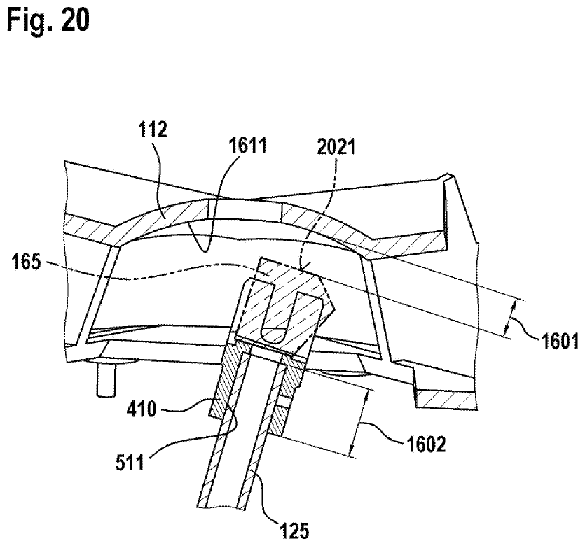

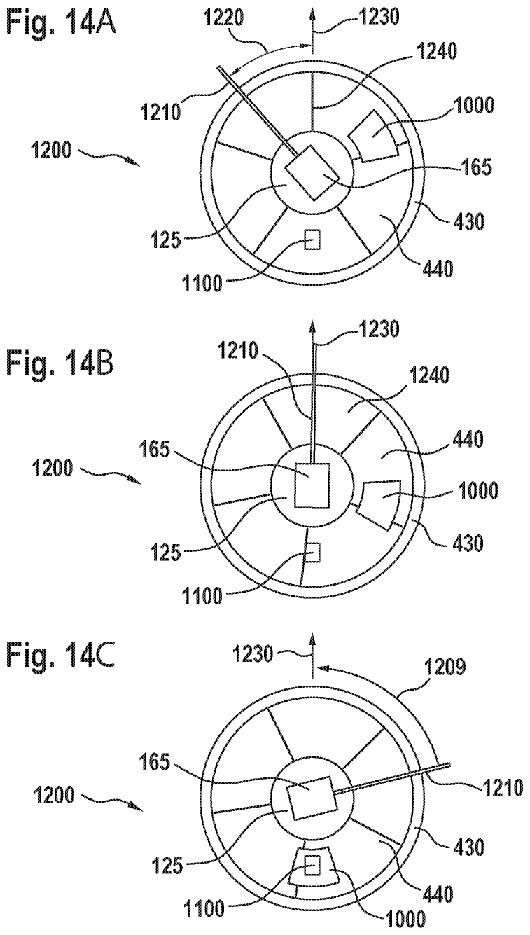

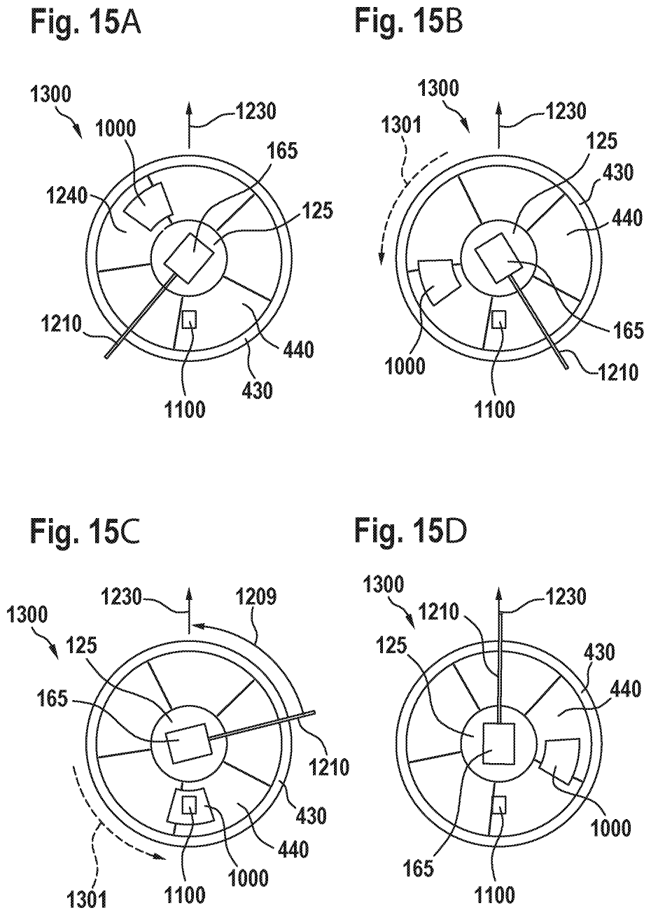

FIG. 20 shows the cage 112 of the housing 110 of FIG. 1 having the spindle 125, which has the bracket 410 and the beam deflector 165. Preferably, the distance 1601 is formed between the inner surface 1611 of the cage 112 and a surface 2021 of the beam deflector 165. The distance 1601 is preferably smaller than the depth 1602 of the interior receptacle 511.

By way of the first adhesive bond 1722 and the second adhesive bond 1723, 1724 of FIG. 19, the beam deflector 165 is securely and reliably fastened to the bracket 410. As a result, as shown in FIG. 20, the cap 1400 may be omitted.

In this alternative embodiment, the wedge prism is preferably fixed directly on the pentaprism by way of an optically transparent adhesive (not shown in FIG. 19 and FIG. 20 for the sake of simplicity).

What is claimed is:

1. A rotary laser, comprising:
a housing;
a drive unit arranged in the housing and configured to rotate a laser beam, wherein the drive unit includes a stator and a rotor configured to rotate a spindle;
a determination unit associated with the spindle and including a toothed disc and a photointerrupter, wherein the toothed disc includes (i) teeth distributed in a circumferential direction, and (ii) a receptacle; and
a magnetic disc is accommodated in the receptacle,
wherein the photointerrupter is configured to determine a relative change in angular position of the spindle.

2. The rotary laser according to claim 1, wherein:
the spindle has a magnetic carrier with an inner shoulder and a circumferential collar,
the magnetic disc is formed at least in sections annularly with an interior recess, and
the interior recess is arranged on the inner shoulder of the magnetic carrier and the magnetic disc abuts the circumferential collar along a longitudinal extension of the spindle.

3. The rotary laser according to claim 2, wherein the toothed disc has an interior recess located on an outer circumference of the circumferential collar.

4. The rotary laser according to claim 3, wherein the toothed disc has a first form-fitting element at its inner recess and the circumferential collar has a second form-fitting element at its outer circumference, and wherein the first and second form-fitting elements are configured to form a positive-locking relationship.

5. The rotary laser according to claim 1, further comprising an adhesive disposed between (i) a bottom side associated with the magnetic disc and facing the toothed disc, and (ii) a bottom surface of the toothed disc to form an adhesive bond.

6. The rotary laser according to claim 2, wherein the magnetic carrier of the spindle and the toothed disc are formed as a single piece.

7. The rotary laser according to claim 6, wherein the spindle has a circumferential collar along its longitudinal extension to facilitate positional fixation.

8. The rotary laser according to claim 1, wherein the determination unit has a reference mark as an absolute reference.

9. The rotary laser according to claim 8, wherein the reference mark is associated with the toothed disc and is configured as a reference tooth or a reference recess, wherein the teeth of the toothed disc have a first width and the reference tooth or the reference recess has a second width, and wherein the second width is greater than the first width.

10. The rotary laser according to claim 1, wherein:
the spindle is connected at its free end, facing away from the drive unit, to a beam deflector,
the spindle has a flattened portion configured to position the beam deflector, and
the beam deflector has a fastening section with a corresponding interior receptacle.

11. The rotary laser according to claim 8, wherein the reference mark is formed as a positioning feature on the magnetic disc and is operatively connected to an absolute encoder.
